(19) United States
(12) Patent Application Publication
(10) Pub. No.: US 2009/0316896 A1
(43) Pub. Date: Dec. 24, 2009

(54) METHOD FOR MANAGING THE NUMBER OF VISUALIZATIONS, SECURITY PROCESSOR AND TERMINAL FOR SAID METHOD

(75) Inventor: Emmanuel Plesse, Chateaugiron (FR)

Correspondence Address: PEARNE & GORDON LLP, 1801 EAST 9TH STREET, SUITE 1200, CLEVELAND, OH, 44114-3108, US

(73) Assignee: VIACCESS, Paris (FR)

(21) Appl. No.: 12/520,339

(22) PCT Filed: Dec. 20, 2007
(86) PCT No.: PCT/FR07/02137

§ 371 Date: Jun. 19, 2009

(30) Foreign Application Priority Data
Dec. 21, 2006 (FR) 0611194

(51) Int. Cl. H04N 7/167; G06F 21/24

(52) U.S. Cl. 380/232; 726/30

(57) ABSTRACT

The invention relates to a method for managing the number of visualizations of an audiovisual content, that comprises: providing a table containing an equal number of cells and of time segments of the audiovisual content, each cell being associated in a bi-unique manner with a respective segment of the audiovisual content; when a segment of the audio-visual content is read, incrementing (114) or decrementing by a predetermined step the number contained in the cell associated with the segment; and calculating (120) the number of visualization already done from the number recorded in each of the cells of the table.

The present invention relates to a method for managing the number of visualizations, a security processor and a terminal for this method.

Methods exist for managing the number of visualizations of an audiovisual content. These methods comprise, for example:
the provision of a digital audiovisual content recorded on a data-recording support, this content being divided into several consecutive time segments which are to be read automatically in a prescribed order,
the provision of a number of authorized visualizations of this audiovisual content,
the reading of the recorded audiovisual content by means of an electronic reader, the electronic reader permitting, in particular, backward skips in order to read a preceding segment before the end of the audiovisual content has been reached,
the calculation of the number of visualizations of the audiovisual content already carried out, and
the prohibition of any new visualization of the audiovisual content if the number of visualizations already carried out is greater than or equal to the number of authorized visualizations and, if it is not, the authorization of a new visualization of the audiovisual content as a whole.

Digital audiovisual contents are, for example, videograms such as films or a television programme.

A segment corresponds to an ordered and consecutive sequence of images and/or sounds. This segment is recorded in a format suitable for being read by the electronic reader and then visualized on a screen. When visualized on a screen, the images and sounds of a segment follow on from each other at a frequency greater than or equal to 50 Hz so as to create an impression of visual and auditory continuity between the various images and sounds of the same segment.

Two segments are said to be consecutive if, during the reading of these segments in the prescribed order, the time lapse separating the instant when the preceding segment ceases to be played from the instant when the following segment starts to be played is less than 1/50 second. Thus, when two segments are consecutive, the user is assured visual and auditory continuity between those two segments.

These management methods are particularly useful in limiting the number of times that a user can visualize a recorded audiovisual content.

It should be noted here that the number of times that the audiovisual content can be visualized is limited by using a calculation of the number of times that the user has already visualized the audiovisual content. This first approach is to be distinguished from a second, concurrent, approach which also aims to limit the number of times that the content can be visualized. This concurrent approach authorizes at the start a period of visualization DVA. Subsequently, the period DVA is decremented in proportion to the time occupied by visualizations of the audiovisual content which have been carried out. This concurrent approach is simple because it is necessary only to measure the visualization time. However, it is very inflexible; in particular, it is very difficult, by measuring purely the visualization time which has already elapsed, to take into account the various possible visualizations of the audiovisual content rendered possible by the backward skips or, conversely, forward skips, which can be carried out under the control of the user.

Potentially, the counting of the number of visualizations of the audiovisual content does not have the disadvantage of this concurrent approach. However, owing to the ability to skip backwards and, optionally, forwards, there are a large number of different strategies for calculating the number of visualizations already carried out.

For example, it may be decided that the audiovisual content has been visualized once when each of its segments has been visualized at least once. This strategy is very permissive, since it also enables a user to visualize a given segment as many times as he wishes by going back systematically after visualizing this segment.

A strategy which is a little less permissive consists in incrementing a counter each time that a segment of the audiovisual content is visualized. This counter is then compared with a predetermined threshold. If the threshold is exceeded, the number of visualizations already carried out is incremented by one. With this strategy, the user can no longer visualize the same segment as many times as he wishes without the number of visualizations already carried out being incremented. On the other hand, conversely, the number of visualizations already carried out can be incremented even if some segments have never yet been visualized.

It is therefore desirable to propose a method for managing the number of visualizations which is sufficiently flexible to permit the implementation of new strategies for calculating the number of visualizations already carried out without involving major modifications to the method.

The invention aims to satisfy this desire. It therefore relates to a method for managing the number of visualizations of an audiovisual content, comprising:
the provision of a table containing as many cells as time segments, each cell being associated in a biunique manner with a respective segment of the audiovisual content, and each cell being suitable for containing a number,
when a segment of the audiovisual content is read by the electronic reader, the incrementation or the decrementation by a predetermined step of the number contained in the cell associated with this segment, and
the calculation of the number of visualizations already carried out, the calculation being performed on the basis of the numbers recorded in each of the cells of the table.

In the above method, the table enables a representation of the number of times that each segment of the audiovisual content has been visualized to be stored. In particular, the content of this table also enables the use of backward skips to be detected. The size distribution of the data contained in this table is therefore sufficient to enable a large number of different strategies to be used to calculate the number of visualizations already carried out. The method is therefore sufficiently flexible for each operator or provider of audiovisual content to be able to define its own strategy for calculating the number of visualizations already carried out.

However, if there is a change in the calculation strategy, only the method of calculating the number of visualizations already carried out and/or only the predetermined step of incrementation or decrementation has/have to be modified, without it being necessary to modify the operations of managing and updating the table. The modifications to be introduced into the management method are therefore limited.

The embodiments of this method may comprise one or more of the following features:
the recording in a non-volatile memory of a multiple visualization licence, this licence comprising at least:
   the number of visualizations authorized,
   the table containing the cells associated in a biunique manner with the time segments of the audiovisual content,
   a cryptographic redundancy, such as a signature produced by means of a cryptographic key and of at least a portion of each of the preceding data,
the verification of the cryptographic redundancy before each new use of the reader in order to visualize the audiovisual content, and
the prohibition of any new visualization if it has not been possible to verify correctly the cryptographic redundancy;
the licence comprises an identifier T_Anti_Reuse of its preceding use,
a security processor equipped with data storage means containing:
   a cryptographic key which can be used to verify the cryptographic redundancy of the licence and/or a cryptographic key enabling the cryptographic redundancy of the licence to be produced, and
   an identifier C_Anti_Reuse of the preceding use of the licence,
after each use of the reader to visualize the audiovisual content, the identifiers T_Anti_Reuse and C_Anti_Reuse are modified so that their respective new values correspond, and
before each new use of the reader to visualize the audiovisual content, the visualization of the audiovisual content is authorized only if the value of the identifier T_Anti_Reuse corresponds to the value of the identifier C_Anti_Reuse;
the selection of an algorithm for calculating the number of visualizations carried out, to be performed during the calculation of the number of visualizations, in accordance with the content of the licence, from a set of several different calculation algorithms capable of being performed, two calculation algorithms being regarded as different if the content of the cells of the table from which the two algorithms give different results is the same;
the provision of several different audiovisual contents and several licences, each of which licences has an audiovisual content identifier which connects it in a biunique manner to only one of the audiovisual contents, and
during the calculation of the number of visualizations already carried out, only the data contained in the licence containing the identifier of the audiovisual content currently being read is used for the calculation of the number of visualizations already carried out;
the provision of a security processor suitable for processing ECM messages (Entitlement Control Message) and EMM messages (Entitlement Management Message),
the transmission of the licence in the form of an EMM message to the security processor, this EMM message containing an identifier of the unique security processor to which it is addressed;
different segments of the audiovisual content are scrambled with different control words, the method comprising for each segment:
the transmission of at least one ECM message to a security processor, each ECM message containing:
   a cryptogram of the control word necessary for unscrambling at least a portion of this segment of the audiovisual content, and
   an identifier of the cell of the table which must be incremented or decremented when this ECM message is used to obtain the control word necessary for unscrambling this segment of the audiovisual content,
the incrementation or decrementation of the number contained in the cell corresponding to the cell identifier contained in the ECM message,
the decryption, by the security processor, of the control word contained in the ECM message transmitted, and
the transmission of the decrypted control word to an unscrambler in order to unscramble at least a portion of the segment of the audiovisual content;
the calculation of the number of visualizations already carried out comprises:
   the determination of the number of cells of the table containing a number which has been incremented or decremented since the last visualization of the audiovisual content, and
   the calculation of the number of visualizations already carried out in accordance with the result of this determination;
during the calculation of the number of visualizations already carried out, the predetermined step used to increment or decrement the number contained in the cell associated with a segment decreases or increases in accordance with the number of times that this segment has already been visualized.

These embodiments of the method also have the following advantages:
the preservation of the data necessary for the calculation of the number of visualizations already carried out in a signed licence renders the falsification of these data difficult,
the comparison of the identifiers T_Anti_Reuse and C_Anti_Reuse prevents a licence from being reinitialized in a preceding state,
the possibility of selecting different algorithms for calculating the number of visualizations already carried out permits the use of different strategies for monitoring the number of visualizations for different audiovisual contents,
the use of an identifier of audiovisual content in each licence enables the calculation of the number of visualizations to be managed individually for each of the audiovisual contents,
the transmission of the licence in the form of an EMM message limits the adaptations to be made to the security processor so that it can receive and process the licence,
the presence of an identifier of the cell of the table which must be incremented or decremented in the ECM message containing the cryptogram of the control word greatly simplifies the management of the table by the security processor,
incrementing the number of visualizations already carried out in accordance with the number of cells in the table which have been modified since the last visualization of the audiovisual content enables the proportion of the audiovisual content that has been visualized to be taken into account in incrementing or decrementing the number of visualizations already carried out, and
varying the increment or decrement step in accordance with the number of times that the segment has already been visualized enables a different importance to be attributed to the first visualization of a segment relative to the following visualizations of this same segment.

The invention relates also to a security processor containing instructions for performing the above management method when these instructions are performed by a computer.

Finally, the invention relates also to a terminal for reading an audiovisual content, this terminal comprising:
a data-recording support containing the digital audiovisual content recorded, this content being divided into several consecutive time segments which are to be read automatically in a prescribed order,
a whole number of visualizations authorized for this audiovisual content,
an electronic reader of audiovisual contents permitting, in particular, backward skips in order to read a preceding segment before the end of the audiovisual content has been reached,
the terminal being suitable:
   for calculating the number of visualizations of this audiovisual content that have already been carried out, and
   for prohibiting any new visualization of the audiovisual content if the number of visualizations already carried out is greater than or equal to the number of visualizations authorized and, if it is not, for authorizing a new visualization of the audiovisual content as a whole,
the terminal comprises a table containing as many cells as time segments, each cell being associated in a biunique manner with a respective segment of the audiovisual content, each cell being suitable for containing a number, and
the terminal is suitable:
   when a segment of the multimedia content is read by the electronic reader, for incrementing or decrementing by a predetermined step the number contained in the cell associated with this segment, and
   for calculating the number of visualizations already carried out from the numbers recorded in each of the cells of this table.

The invention will be better understood on reading the following description which is given purely by way of non-limiting example and with reference to the drawings, in which:

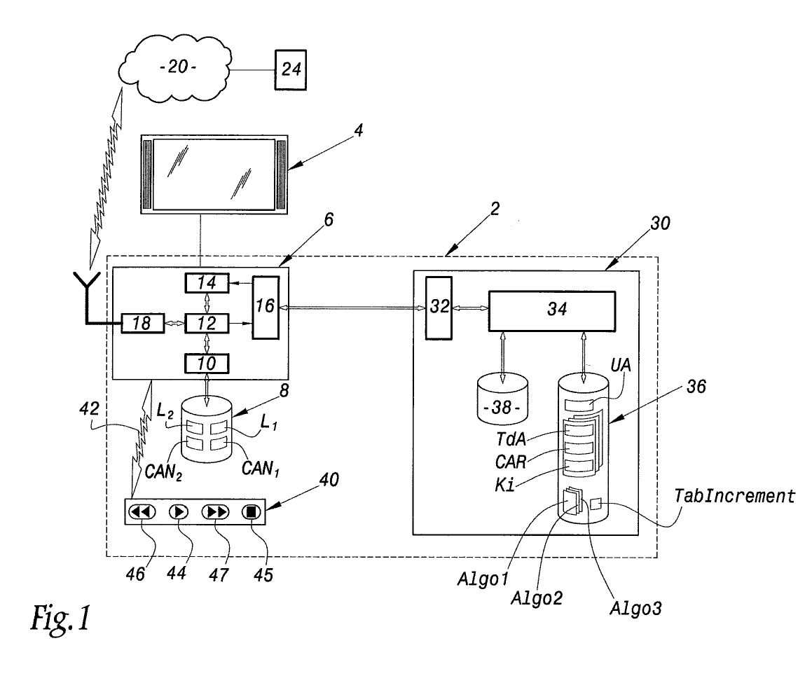

FIG. 1 is a diagrammatic illustration of a terminal for reading recorded digital audiovisual contents,

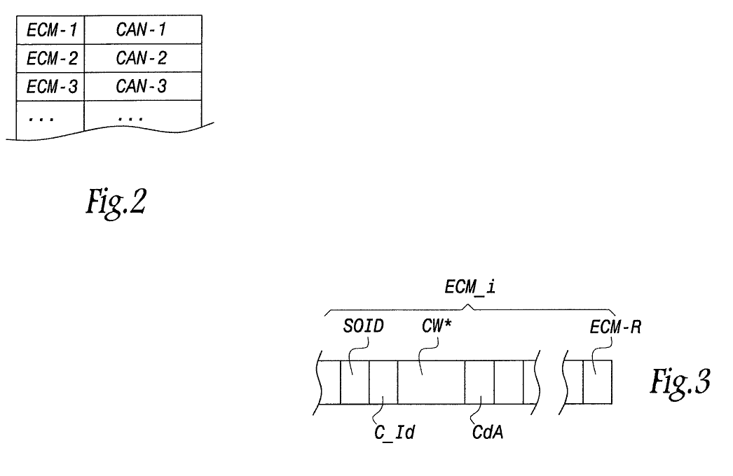

FIG. 2 is a diagrammatic illustration of an audiovisual content which can be visualized by means of the terminal of FIG. 1,

FIG. 3 is a diagrammatic illustration of an ECM (Entitlement Control Message) recorded with the audiovisual content of FIG. 2,

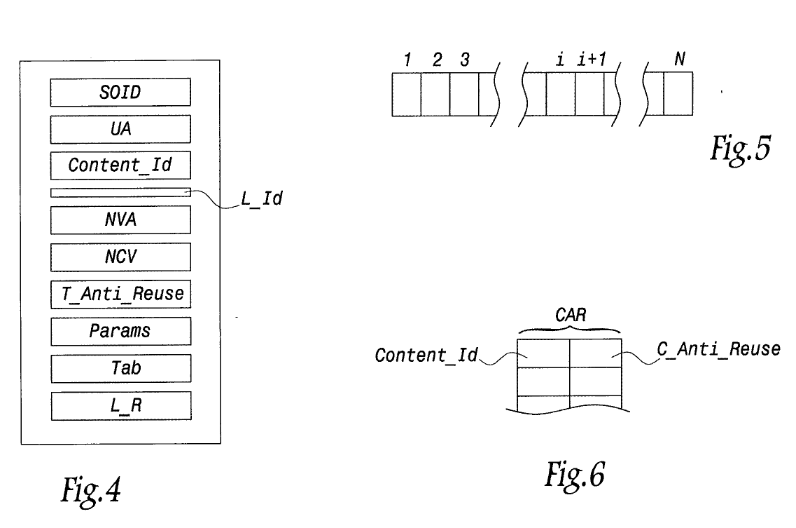

FIG. 4 is a diagrammatic illustration of a licence used in the terminal of FIG. 1,

FIG. 5 is an illustration of the structure of a table contained in the licence of FIG. 4,

FIG. 6 is an illustration of an anti-replay list contained in a security processor of the terminal of FIG. 1,

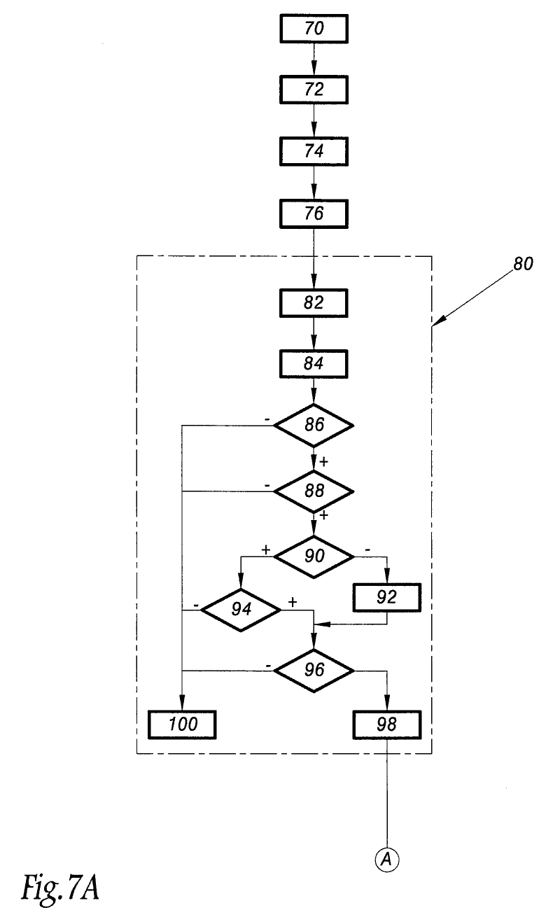

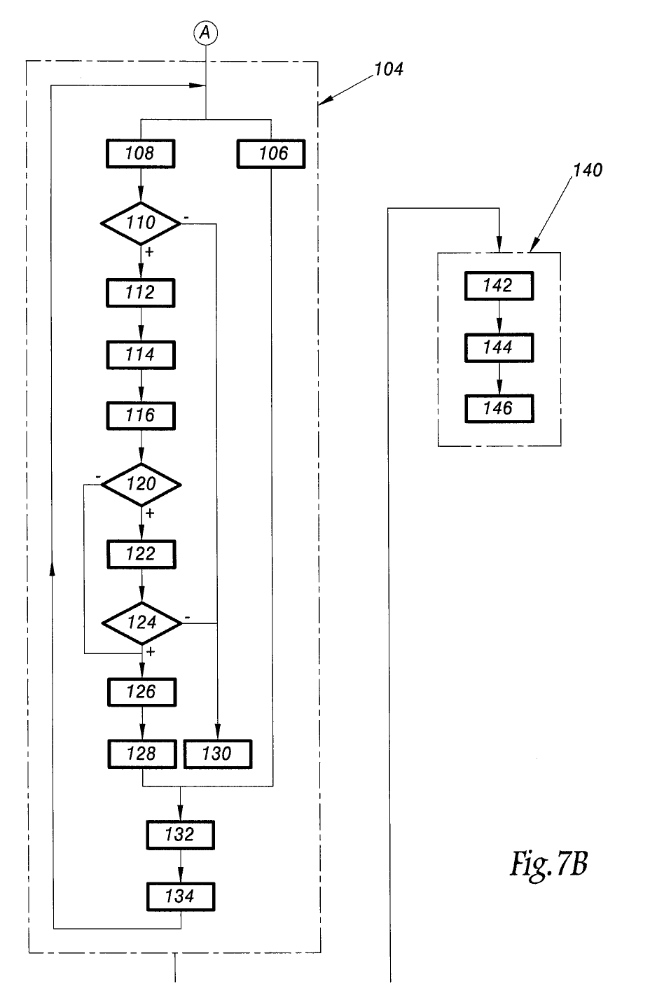

FIGS. 7A and 7B are flow charts of a method for managing the number of visualizations of the audiovisual content used in the terminal of FIG. 1,

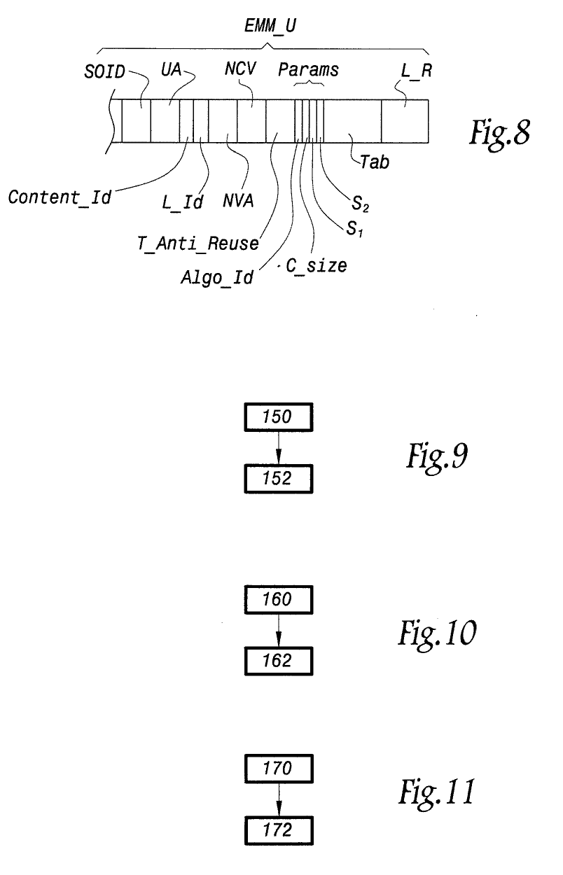

FIG. 8 is a diagrammatic illustration of the structure of an EMM-U (Entitlement Management Message having a Unique address) generated during the performance of the method of FIG. 7, and

FIGS. 9 to 11 are flow charts of three algorithms, respectively, for calculating the number of visualizations already carried out.

In these Figures, the same references are used to indicate the same elements.

In the description given hereinafter, the features and functions which are well known to the person skilled in the art are not described in detail.

FIG. 1 shows a terminal 2 for reading digital audiovisual content. This terminal 2 is suitable for controlling the display on a screen 4 of the audiovisual contents read in such a manner that these contents can be visualized by a user. “User” here means a human being.

The screen 4 is, for example, typically a television screen.

The terminal 2 comprises a decoder 6 connected to a data-recording support 8. The audiovisual contents are recorded on this support 8. For example, here, by way of illustration, two audiovisual contents CAN₁ and CAN₂ and their respective licences L₁ and L₂ are recorded in the support 8. The contents CAN₁ and CAN₂ are, for example, audiovisual contents scrambled by means of control words CW.

The structure of one of these audiovisual contents is illustrated in FIG. 2.

The audiovisual content is divided into a large number of time segments CAN_{—1} to CAN_N. These segments CAN_i follow each other in a prescribed order. For example, the segment CAN_1 corresponds to the first segment which must be read and the segment CAN_N corresponds to the last segment which must be read. Here, each segment CAN_i is scrambled by means of a single control word CW which is different from that used to scramble the preceding segments and the following segments. Thus, in this particular embodiment, each segment corresponds to a cryptoperiod.

By way of example, the duration of a cryptoperiod is generally 10 seconds.

Each segment or cryptoperiod CAN_i is associated with an ECM message (Entitlement Control Message) denoted ECM_i. The message ECM_i contains a cryptogram CW* of the control word CW used to scramble the segment CAN_i. The messages ECM_i are recorded on the support 8 at the same time as the segments CAN_i.

The structure of these messages ECM_i is, for example, in conformity with the standard UTE C₉₀-007 “Conditional access system for digital broadcasting systems” used in the field of scrambled multimedia signal transmission by means of long-distance data transmission networks, such as, for example, networks involving satellites.

FIG. 3 shows only the portions of the structure of the message ECM_i that are useful in understanding the description hereinafter. The message ECM_i comprises a field SOID containing both an identifier of the operator that has broadcast this audiovisual content and an identifier of the cryptographic context to be applied. The identifier of the cryptographic context to be applied enables, in particular, a security processor to identify which cryptographic key(s) is (are) to be used to process this ECM message.

The message ECM_i also comprises:
a field C_Id containing an identifier C_Id of a cell of a table,
a field CW* containing the cryptogram CW* of a control word CW,
a field CdA containing conditions of access CdA to the audiovisual content, and
a field ECM_R containing a cryptographic redundancy, such as an MAC (Message Authentication Code) or a cryptographic signature of the ECM_i relating to a portion of the data contained in each of the preceding fields of this message ECM_i.

The identifier C_Id establishes a biunique relationship between this message ECM_i and a cell of the table of FIG. 5.

The structure of the licences L₁ and L₂ is, for example, in accordance with the licence structure shown in FIG. 4. To be more precise, each licence comprises the following fields:
a field SOID having the same content as the field SOID of the messages ECM_i associated with the audiovisual content corresponding to this licence,
a field UA containing a unique identifier UA of a security processor,
a field Content_Id containing an identifier Content_Id of the audiovisual content to which this licence corresponds,
a field L_Id containing an identifier L_Id of this licence making it possible, in particular, to distinguish this licence from another licence containing exactly the same identifiers SOID, UA and Content_Id,
a field NVA containing a positive integer NVA corresponding to the number of visualizations authorized for the audiovisual content identified by the identifier Content_Id,
a field NCV containing an integer NCV used for storing the number of segments already visualized during the preceding reading of the audiovisual content associated with this licence,
a field T_Anti_Reuse containing an identifier T_Anti_Reuse of the preceding use of the licence, used to prevent the same licence being reused several times; typically, this identifier is a number whose value increases strictly at each new use of the licence,
a field Params containing different parameters of an algorithm for calculating the number of visualizations already carried out,
a field Tab containing the table of FIG. 5, and
a field L_R containing a cryptographic redundancy L_R, such as an MAC or a cryptographic signature relating to at least a portion of the data contained in each of the preceding fields.

By way of example, the field Params contains values for the following parameters:
C_Size,
S₁,
S₂, and
Algo_Id.

The value of these parameters will emerge in the light of the description of FIGS. 9 to 11.

The cryptographic redundancy L_R is constructed by using a cryptographic algorithm and a cryptographic key.

FIG. 5 shows diagrammatically an example of a possible structure for the table Tab. Here, this table is formed by N successive cells classified in the order ranging from 1 to N. N is an integer equal to the number of segments contained in the audiovisual content with which the licence is associated. Each cell is to contain one encoded number out of a number of bits which can be parameterized by means of the parameter C_Size contained in the field Params of the licence.

The values 1, 2, 3, . . . , i, I+1, . . . , N indicated above each of these cells represent the value of the identifier C_Id enabling the cell located just below to be identified.

The decoder 6 comprises:
an electronic reader 10 suitable for reading and writing data on the support 8,
a filter 12 suitable for orienting the scrambled audiovisual content towards an unscrambler and a decoder 14 and for sending the messages ECM_i associated with this scrambled audiovisual content to a decoder/card interface 16,
the unscrambler and decoder 14.

Purely by way of illustration, the decoder 6 here comprises a receiver 18 suitable for receiving via a data-transmission wireless network 20 scrambled audiovisual contents and the ECM messages associated with that audiovisual content. For example, the scrambled audiovisual contents as well as the ECM messages are broadcast by a remote transmitter 24 to a large number of remote terminals, such as the terminal 2.

The terminal 2 also comprises a security processor 30 connected to the decoder 6. This security processor 30 is configured to process ECM messages and EMM messages (Entitlement Management Message) and to carry out the encryption and decryption operations necessary for the operation of the terminal 2.

To that end, the processor 30 comprises:
an interface 32 suitable for cooperating with the interface 16 of the decoder in order to receive from the decoder ECM and EMM messages,
a computer 34 suitable for processing the EMM and ECM messages received via the interface 32,
a non-volatile memory 36 in which the various data necessary for the encryption/decryption operations are also stored, and
a volatile memory 38 in which temporary processing results are stored.

For example, the processor 30 is a removable security processor, such as a chip card.

The memory 36 contains:
a unique identifier UA of the security processor enabling the processor 30 to be distinguished from all of the security processors capable of being used in the decoder 6,
three different algorithms Algo1, Algo2 and Algo3 each enabling the number of visualizations already carried out to be calculated.

For each identifier of cryptographic context, the memory 36 also contains the following data:
access rights TdA which are to be compared with the access conditions CdA contained in an ECM message in order to determine whether this ECM message can or cannot be processed by the processor 30,
a list CAR which is to prevent a licence from being reused,
cryptographic keys Kᵢ enabling the encryption and decryption operations necessary for processing the ECM and EMM messages to be carried out.

FIG. 6 shows an example of a possible structure for the list CAR. This list comprises, for example, a first column containing the identifiers Content_Id and a second column comprising the identifier C_Anti_Reuse associated with the identifier Content_Id. The list CAR contains as many lines as licences already read by the reader 10.

The memory 36 also comprises a table TabIncrement which is to be used in conjunction with the algorithm Algo3. The table TabIncrement is, for example, the following:

| | | | | | | | | | |
|---|---|---|---|---|---|---|---|---|---|
| X | 0 | 1 | 2 | 3 | 4 | 5 | 6 | 7 | X + 1 |
| Y | 0 | 1 | 0.5 | 0.3 | 0.2 | 0.2 | 0.2 | 0.2 | 0.1 |
| Z | 0 | 1 | 1.5 | 1.8 | 2 | 2.2 | 2.4 | 2.6 | Y + 0.1 |

The first line X of this table contains integers each corresponding to a number of times that a segment has been visualized. The second line Y associates an incrementation step with each of those integers. It will be appreciated that this incrementation step is here a monotonic decreasing function of the number of times that a segment has already been read. The line Z gives the number actually taken into account by the algorithm for each number of visualizations of a segment.

Finally, the terminal 2 comprises a remote control 40 enabling the decoder 6 to be controlled by means of a wireless link 42. In order to simplify the illustration, only the following keys of the remote control 40 are shown:
a key 44 for triggering the reading of an audiovisual content selected from the various audiovisual contents recorded on the support 8,
a key 45 for stopping the reading of an audiovisual content in order, for example, to move on to the reading of another audiovisual content or quite simply to stop any reading,
a key 46 for skipping backwards, that is to say, for passing directly from the segment currently being read to a preceding segment without it being necessary to read the intermediate segments between the segment currently being read and the preceding segment, and
a key 47 for skipping forwards, that is to say, for passing directly from the segment currently being read to a following segment without having to read the intermediate segments located between the segment currently being read and the following segment.

The operation of the terminal 2 will now be described with reference to the method of FIG. 7. Initially, in a step 70, the transmitter 24 sends to the terminal 2 a scrambled audiovisual content and the corresponding ECM messages by way of the network 20. In a step 72, the terminal 2 records this scrambled audiovisual content and the corresponding ECM messages on the support 8 in order to obtain, for example, the recorded audiovisual content CAN₁.

Then, in a step 74, the transmitter 24 transmits the licence L₁ to the terminal 2 by way of the network 20 or by any other mode of communication. In this case, the licence involved is the initial version of the licence L₁, containing, in particular, the initial value of the number NVA of authorized visualizations of this content. Preferably, this initial value permits at least two complete visualizations of the content. For example, in step 74, this licence is transmitted in a message EMM_U, the structure of which is shown in FIG. 8. To be more precise, the structure of this message EMM_U conforms to the standard UTE C90-007 (already mentioned) in the field of scrambled multimedia signal transmission. FIG. 8 shows only the elements necessary to understand the description hereinafter.

To be more precise, the message EMM_U comprises the same fields as those already described with reference to FIG. 4, so that their description will not be repeated here in detail.

In a step 76, only the terminal 2 whose security processor corresponds to the identifier UA contained in the message EMM_U records the licence received on the support 8.

It will be appreciated that the licence can be sent before or at the same time as the content, and the same applies to its recording on the support 8. Steps 70 and 74 may thus be simultaneous or interchanged, as may steps 72 and 76, provided that steps 72 and 76 still follow steps 70 and 74, respectively.

Later, the user of the terminal 2 triggers the reading of one of the audiovisual contents recorded on the support 8 by means of the remote control 40, for example. It is assumed here that the reading of the content CAN₁ is triggered. A phase 80, referred to as a log-on, then commences.

Initially, in a step 82, if several licences exist for the same audiovisual content, the user selects the licence to be used to visualize this content. Here, the licence L₁ is automatically selected since only this licence is associated with the content CAN₁.

Then, in a step 84, the terminal sends the selected licence to the processor 30 by way of the interfaces 16 and 32. For that purpose, the decoder transmits the message EMM_U representing the licence L₁, this message EMM_U being identical with that of FIG. 8.

In a step 86, the processor 30 checks that the identifier UA contained in the message EMM_U received corresponds to the identifier UA recorded in the memory 36. For example, in step 86, the processor 30 checks whether these identifiers UA are identical.

In the affirmative, it goes on to a step 88 in which the processor 30 checks the authenticity of the licence received by means of the cryptographic redundancy L_R. To be more precise, in step 88, the processor 30 goes on, on the basis of the content of the fields of the licence received, to operations similar to those carried out previously in order to obtain the redundancy L_R. In particular, in step 88, at least one of the operations involves an encryption or decryption with a cryptographic key. For example, the cryptographic key used in the cryptographic redundancy is identified thanks to the context identifier contained in the field SOID of the message EMM_U. If the processing of the cryptographic redundancy by the processor 30 leads to a positive result, for example, if the redundancy constructed by the processor 30 is identical with the redundancy contained in the field L_R, then the licence is regarded as authentic and correct and the processor goes on to a step 90.

In step 90, the processor 30 seeks the identifier C_Anti_Reuse associated with the identifier Content_Id contained in the licence received. If none of the identifiers in the list CAR corresponds to the identifier Content_Id received, the processor 30 adds, in a step 92, the identifier Content_Id received to the list CAR and associates this identifier with an identifier C_Anti_Reuse having a value initialized to zero.

In the opposite case, in a step 94, the processor 30 compares the value of the identifier T_Anti_Reuse of the licence received with the value of the identifier C_Anti_Reuse associated with the identifier Content_Id in the list CAR. If the identifiers correspond, for example, if the values are identical, then the processor 30, in a step 96, checks that the number NVA contained in the licence received is strictly higher than zero. In the affirmative, in a step 98, the processor 30 records in its memory 38 the parameters which are contained in the field Params, and the numbers NVA, NCV and the table Tab which are contained in the licence received.

If one of the checks carried out in steps 86, 88, 94 and 96 fails, the processor 30 goes on to a step 100 for stopping the processing of the licence received and stopping the decryption of the scrambled audiovisual content.

At the end of step 98, phase 80 is completed and a phase 104 for reading the audiovisual content commences automatically.

At the beginning of phase 104, in a step 106, the first segment CAN_1 of the audiovisual content CAN₁ is read and transmitted to the unscrambler 14. In parallel, in a step 108, the associated message ECM_1 is transmitted to the processor 30.

Subsequently, in a step 110, the access conditions CdA contained in the message ECM_1 are compared with the access rights TdA contained in the memory 36. If the access conditions correspond to the access rights TdA, the method continues with a step 112 for extracting the identifier C_Id contained in the message ECM_1 received.

Then, in a step 114, the processor 30 increments by a specified step the cell of the table Tab received corresponding to the identifier C_Id extracted. The specified step depends here on the parameter Algo_Id. Step 114 is performed only if the maximum size of the cell specified by the identifier C_Id has not already been reached.

In a step 116, the processor 30 also increments the number NCV by the specified step.

Then, in a step 120, the processor determines whether a new visualization of the audiovisual content has been carried out. This determination is effected by performing the algorithm corresponding to the identifier Algo_Id. Algorithms corresponding to the identifiers Algo1, Algo2 and Algo3, respectively, are described with reference to FIGS. 9 to 11, respectively.

In the affirmative, it goes on to a step 122 during which the number NVA is incremented and, if necessary, the table Tab and the number NVC are updated.

In a step 124, the processor 30 checks that the number NVA is strictly higher than zero. If the number NVA is still strictly higher than zero, then, in a step 126, the processor goes on to extract the cryptogram CW* contained in the message ECM_1 received and then decrypts this cryptogram with a decryption key recorded in the context associated with the content of the field SOID. Subsequently, in a step 128, the decrypted control word CW is transmitted to the unscrambler 14.

If, in step 110, the access conditions received do not correspond to the recorded access rights, or if, in step 124, the number NVA is less than or equal to zero, then the processor 30 immediately goes on to a step 130 for stopping the processing of the messages ECM_i received. Consequently, no new control word CW is supplied to the unscrambler, which prevents the correct unscrambling of the audiovisual content recorded on the support 8.

If, in step 120, it has been determined that a new visualization has not been carried out, then the method passes from step 120 directly to step 126.

At the end of step 128, in a step 132, the unscrambler 14 unscrambles the segment CAN_1 using the control word CW received from the processor 30. Then, in a step 134, the unscrambled segment is displayed in uncoded form on the screen 4.

At the end of step 134, the method returns automatically to steps 106 and 108 in order to read the following segment of the audiovisual content CAN₁.

If no use is made of forward or backward skips triggered by means of the keys 46 and 47, steps 106 to 134 are reiterated for each of the segments CAN_i of the content CAN₁ in the order of those segments.

In phase 104, the user can also use the keys 46 and 47 to bring about backward or forward skips. Under these conditions, the segments of the content CAN₁ are no longer read in the prescribed order. However, steps 106 to 134 continue to be applied to each of the segments read. In other words, the use of the keys 46 and 47 does not end the current reading session.

After visualizing the audiovisual content, the user may decide to end this visualization, for example, by pressing the key 45. At that moment, the processor 30 goes on to a phase 140 for closing the current session. At the beginning of phase 140, in a step 142, the processor 30 increments the number constituting the identifier C_Anti_Reuse associated with the identifier Content_Id in the list CAR. Then, in a step 144, the processor generates an updated licence, that is to say, the updated licence contains the new values of the numbers NVA, NCV, T_Anti_Reuse and Tab, and also a reconstituted value L_R.

The value of the identifier T_Anti_Reuse of the updated licence is identical with that of the identifier C_Anti_Reuse associated with the identifier Content_Id in the list CAR.

The redundancy L_R is constructed on the basis of the new values of the licence and by using the appropriate cryptographic key recorded in the context associated with the identifier SOID.

Subsequently, in a step 146, the processor 30 transmits the updated licence L₁ to the decoder 6 which records it in place of the licence L₁ previously recorded on the support 8.

A description will now be given of three examples of algorithms for calculating the number of visualizations, such as can be used in step 120. Each algorithm is indicated by a particular value of the parameter Algo_Id contained in the licence.

FIG. 9 illustrates the algorithm Algo1 for calculating the number of visualizations already carried out. The algorithm Algo1 uses two parameters contained in the licence, namely the threshold S₁ and the parameter C_Size. In order to perform the algorithm Algo1, the parameter C_Size is fixed at one bit.

During the performance of the algorithm Algo1, in a step 150, the processor 30 detects a discontinuity in the reading of the audiovisual content. For example, this discontinuity may be detected in response to the depression of one of the keys 46 and 47. The discontinuity may also be detected by observing a discontinuity in the values of the identifiers C_Id contained in the ECM_i which have been received.

Then, when this discontinuity has been detected, in a step 152, the processor 30 considers that a new visualization of the audiovisual content has been carried out if the number of cells in the table Tab containing a “1” is greater than or equal to the threshold S₁. In the affirmative, in step 122, the number NVA is decremented by one and all of the cells in the table Tab are reinitialized to the value zero.

Step 152 is also carried out automatically when the end of the last segment of the audiovisual content is reached.

The algorithm Algo1 permits the repeated visualization of a content portion restricted by the threshold S₁ but limits the number of visualizations as soon as the visualized portion of the content is larger.

FIG. 10 illustrates the algorithm Algo2 for calculating the number of visualizations already carried out. This algorithm Algo2 uses the parameters C_Size, S₁ and S₂ contained in the licence. Here, the parameter C_Size is equal to one bit.

In a step 160, which is, for example, identical with step 150, a discontinuity in the reading of the audiovisual content is detected. In response, in a step 162, it is determined that a new visualization has been carried out if the number of cells in the table Tab containing a “1” is greater than the threshold S₁ or if the number NCV is greater than or equal to the threshold S₂.

If it is determined that a new visualization has been carried out or at the end of the reading of the last segment, in step 122, the number NVA is decremented by one and all of the cells in the table Tab as well as the value of the number NCV are reinitialized to the value zero.

The algorithm Algo2 differs from Algo1 in that it limits the visualization of a restricted portion of the content by the action of the threshold S₂.

FIG. 11 illustrates the algorithm Algo3. The algorithm Algo3 uses the parameters C_Size and S₂ of the licence received. In addition, the identifier of the algorithm Algo3 indicates to the processor 30 that the increment step used in step 116 is determined from the table TabIncrement.

Then, in a step 170, the processor 30 detects a discontinuity in the reading of the audiovisual content. In response or at the end of the reading of the last segment, in a step 172, it is determined that a new visualization has been carried out if the number NCV is greater than the threshold S₂. In the affirmative, in step 122, the number NVA is decremented by one and the number NCV as well as all of the cells in the table Tab are reinitialized to zero. It will be noted that, in this last embodiment, the number NCV is incremented by one when a segment is visualized for the first time. On the other hand, when this same segment is visualized a second time, the number NCV is incremented by only 0.5. Then, if this segment is visualized again at other times, the increment used in step 116 is even smaller. Thus, by this expedient, a lesser importance is attributed to later visualizations of the same segment than to the first visualization.

Numerous other embodiments are possible. For example, the licence may be transmitted from the transmitter to the decoder, then from the decoder to the security processor, using a message other than a message EMM_U. For example, any signed data structure may be used.

The security processor 30 has been described here as being a removable processor. In a variant, the processor 30 is integrated in the decoder 6 and secured permanently thereto.

In a variant, the licence does not contain a field L_R and is therefore not protected by a signature.

If there is only one licence per audiovisual content, the field L_Id may be omitted.

If there are several possible licences for the same audiovisual content, the selection of the licence to be used may be automatic. For example, the use of the oldest licence may be given priority.

Here, each segment corresponds to one cryptoperiod. In a variant, one segment corresponds to several successive cryptoperiods. In that case, several messages ECM_i will comprise the same identifier C_Id.

In another embodiment, the cells in the table Tab may be decremented instead of incremented.

In embodiments in which the table Tab would never be reinitialized, the field NCV may be omitted.

The licence may also be common to several audiovisual contents recorded on the support 8. In that case, the identifier Content_Id identifies, not a single audiovisual content, but a group of audiovisual contents capable of being visualized by means of the terminal 2.

Some steps of the method of FIG. 4 can be interchanged. For example, step 110 can be carried out after step 124.

Here, the monitoring of the number of visualizations already carried out is effected after each segment has been read. In a variant, this monitoring can be carried out purely at the end of the reading session. Thus, in this embodiment, there is nothing to prevent a user from visualizing an audiovisual content as many times as he wishes in the course of one and the same session. On the other hand, the number of sessions will be limited.

In another variant, the incrementation step used by the algorithm may be supplied by a parameter of the ECM message in order to take into account the variable advantage of one portion or another of the content.

The support 8 may be a removable support, such as, for example, a DVD-RW (Digital Video Disc-Rewritable) or a CD-RW (Compact Disc-Rewritable). It may be a non-rewritable removable support (DVD-R, CD-R), in which case the licence is stored in a non-volatile memory of the electronic reader.

What has been described here in the case of audiovisual contents may also be applied to audiophonic contents without a video.

What has been described here in the case of the display of an audiovisual content may also be applied to the controlled redistribution of such a content in a local or domestic network.

carried out is greater than or equal to the number of visualizations authorized and, if it is not, for authorizing a new visualization of the audiovisual content, characterized in that the terminal comprises a table (FIG. 5) containing as many cells as time segments, each cell being associated in a biunique manner with a respective segment of the audiovisual content, each cell being suitable for containing a number, and in that the terminal is suitable:
when a segment of the multimedia content is read by the electronic reader, for incrementing or decrementing by a predetermined step the number contained in the cell associated with this segment, and
for calculating the number of visualizations already carried out from the numbers recorded in each of the cells of this table.

1. Method for managing the number of visualizations of an audiovisual content, this method comprising:
the provision (72) of a digital audiovisual content recorded on a data-recording support, this content being divided into several consecutive time segments which are to be read automatically in a prescribed order,
the provision (74) of a number of authorized visualizations of this audiovisual content,
the reading (106) of the recorded audiovisual content by means of an electronic reader, the electronic reader permitting, in particular, backward skips in order to read a preceding segment before the end of the audiovisual content has been reached,
the calculation (120, 122) of the number of visualizations of the audiovisual content already carried out, and
the prohibition (130) of any new visualization of the audiovisual content if the number of visualizations already carried out is greater than or equal to the number of authorized visualizations and, if it is not, the authorization of a new visualization of the audiovisual content, characterized in that the method comprises:
the provision (84) of a table containing as many cells as time segments, each cell being associated in a biunique manner with a respective segment of the audiovisual content, and each cell being suitable for containing a number,
when a segment of the audiovisual content is read by the electronic reader, the incrementation (114) or the decrementation by a predetermined step of the number contained in the cell associated with this segment, and
the calculation (120; 152; 162; 172) of the number of visualizations already carried out, the calculation being performed on the basis of the numbers recorded in each of the cells of the table.

2. Method according to claim 1, wherein the method comprises:
the recording (76) in a non-volatile memory of a multiple visualization licence, this licence comprising at least:
the number of visualizations authorized,
the table containing the cells associated in a biunique manner with the time segments of the audiovisual content,
a cryptographic redundancy produced by means of a cryptographic key and of at least a portion of each of the preceding data,
the verification (88) of the cryptographic redundancy before each new use of the reader in order to visualize the audiovisual content, and
the prohibition (100) of any new visualization if it has not been possible to verify correctly the cryptographic redundancy.

3. Method according to claim 2, wherein:
the licence comprises an identifier T_Anti_Reuse of its preceding use,
a security processor (30) equipped with data storage means containing:
a cryptographic key which can be used to verify the cryptographic redundancy of the licence and/or a cryptographic key enabling the cryptographic redundancy of the licence to be produced, and
an identifier C_Anti_Reuse of the preceding use of the licence,
after each use of the reader to visualize the audiovisual content, the identifiers T_Anti_Reuse and C_Anti_Reuse are modified (142, 144) so that their respective new values correspond, and
before each new use of the reader to visualize the audiovisual content, the visualization of the audiovisual content is authorized (94) only if the value of the identifier T_Anti_Reuse corresponds to the value of the identifier C_Anti_Reuse.

4. Method according to claim 1, wherein the method comprises the selection (120) of an algorithm for calculating the number of visualizations carried out, to be performed during the calculation of the number of visualizations, in accordance with the content of the licence, from a set of several different calculation algorithms capable of being performed, two calculation algorithms being regarded as different if the content of the cells of the table from which the two algorithms give different results is the same.

5. Method according to claim 1, wherein the method comprises:
the provision of several different audiovisual contents and several licences, each of which licences has an audiovisual content identifier which connects it in a biunique manner to only one of the audiovisual contents, and
during the calculation of the number of visualizations already carried out, only the data contained in the licence containing the identifier of the audiovisual content currently being read is used for the calculation of the number of visualizations already carried out.

6. Method according to claim 1, wherein the method comprises:
the provision of a security processor suitable for processing ECM messages (Entitlement Control Message) and EMM messages (Entitlement Management Message),
the transmission (84) of the licence in the form of an EMM message to the security processor, this EMM message containing an identifier of the unique security processor to which it is addressed.

7. Method according to claim 1, wherein different segments of the audiovisual content are scrambled with different control words, the method comprising for each segment:
the transmission (108) of at least one ECM message to a security processor, each ECM message containing:
a cryptogram of the control word necessary for unscrambling at least a portion of this segment of the audiovisual content, and
an identifier (C_d) of the cell of the table which must be incremented or decremented when this ECM message is used to obtain the control word necessary for unscrambling this segment of the audiovisual content,
the incrementation (114) or decrementation of the number contained in the cell corresponding to the cell identifier contained in the ECM message,
the decryption (126), by the security processor, of the control word contained in the ECM message transmitted, and
the transmission (128) of the decrypted control word to an unscrambler in order to unscramble at least a portion of the segment of the audiovisual content.

8. Method according to claim 1, wherein the calculation of the number of visualizations already carried out comprises:
the determination (152; 162) of the number of cells of the table containing a number which has been incremented or decremented since the last visualization of the audiovisual content, and
the calculation (122) of the number of visualizations already carried out in accordance with the result of this determination.

9. Method according to claim 1, wherein, during the calculation of the number of visualizations already carried out, the predetermined step used to increment (114) or decrement the number contained in the cell associated with a segment decreases or increases in accordance with the number of times that this segment has already been visualized.

10. Method according to claim 1, Security processor, characterized in that it comprises instructions for performing a method according to any one of the preceding claims, when these instructions are performed by a computer (34).

11. Terminal for reading an audiovisual content, comprising:
a data-recording support (8) containing the digital audiovisual content recorded, this content being divided into several consecutive time segments which are to be read automatically in a prescribed order,
a whole number (NVA) of visualizations authorized for this audiovisual content,
an electronic reader (10) of audiovisual contents permitting, in particular, backward skips in order to read a preceding segment before the end of the audiovisual content has been reached,
the terminal being suitable:
for calculating the number of visualizations of this audiovisual content that have already been carried out, and
for prohibiting any new visualization of the audiovisual content if the number of visualizations already carried out is greater than or equal to the number of visualizations authorized and, if it is not, for authorizing a new visualization of the audiovisual content, characterized in that the terminal comprises a table (FIG. 5) containing as many cells as time segments, each cell being associated in a biunique manner with a respective segment of the audiovisual content, each cell being suitable for containing a number, and in that the terminal is suitable:
when a segment of the multimedia content is read by the electronic reader, for incrementing or decrementing by a predetermined step the number contained in the cell associated with this segment, and
for calculating the number of visualizations already carried out from the numbers recorded in each of the cells of this table.
